(19) United States
(12) Patent Application Publication
(10) Pub. No.: US 2025/0193652 A1
(43) Pub. Date: Jun. 12, 2025

(54) DYNAMIC eSIM CUSTOMIZATION WITH PRESET TEMPLATES

(71) Applicant: Apple Inc., Cupertino, CA (US)

(72) Inventors: Jean-Marc PADOVA, San Francisco, CA (US); Aurelien P. RABOISSON, San Diego, CA (US); Li LI, Los Altos, CA (US); Ngabin S. NG, San Diego, CA (US); Viswanath NAGARAJAN, San Jose, CA (US)

(21) Appl. No.: 18/887,593

(22) Filed: Sep. 17, 2024

Related U.S. Application Data
(60) Provisional application No. 63/608,682, filed on Dec. 11, 2023.

(51) Int. Cl. H04W 8/18

(52) U.S. Cl. CPC H04W 8/18

(57) ABSTRACT

This application sets forth techniques for dynamically customizing an electronic subscriber identity module (eSIM) for a wireless device using a preset eSIM template. Mobile network operator (MNO) specific eSIM templates can be loaded during manufacturing or obtained post-manufacturing from an MNO asset server. An MNO specific eSIM template can include MNO files and data, including proprietary applets and algorithms, and can be customized to include device specific data in the field.

### CROSS-REFERENCE TO RELATED APPLICATIONS

The present application claims the benefit of U.S. Provisional Application No. 63/608,682, entitled “DYNAMIC eSIM CUSTOMIZATION WITH PRESET TEMPLATES,” filed Dec. 11, 2023, the content of which is incorporated by reference herein in its entirety for all purposes.

### FIELD

The described embodiments set forth techniques for dynamically customizing an electronic subscriber identity module (eSIM) for a wireless device using a preset eSIM template. Mobile network operator (MNO) specific eSIM templates can be loaded during manufacturing or obtained post-manufacturing from an MNO asset server. An MNO specific eSIM template can include MNO files and data, including proprietary applets and algorithms, and can be customized to include device specific data in the field.

### BACKGROUND

Many wireless devices are configured to use removable Universal Integrated Circuit Cards (UICCs) that enable the wireless devices to access services provided by Mobile Network Operators (MNOs). In particular, each UICC includes at least a microprocessor and a non-volatile memory (NVM), where the NVM is configured to store an MNO profile that the wireless device can use to register and interact with an MNO to obtain wireless services via a cellular wireless network. A profile may also be referred to as subscriber identity module (SIM). Typically, a UICC takes the form of a small removable card, commonly referred to as a SIM card, which is inserted into a UICC-receiving bay of a wireless device. In more recent implementations, UICCs are being embedded directly into system boards of wireless devices as embedded UICCs (eUICCs), which can provide advantages over traditional, removable UICCs. The eUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. An eUICC can store a number of MNO profiles—also referred to herein as eSIMs—and can eliminate the need to include UICC-receiving bays in wireless devices.

A wireless device can include a bootstrap eSIM, also referred to as a provisioning eSIM, installed at a time of manufacture or provisioned dynamically to the wireless device thereafter. The bootstrap eSIM provides a limited functionality connectivity option to allow the wireless device to connect to a cellular wireless network for essential services, such as for device activation, user eSIM installation, or the like. Presently, a bootstrap eSIM can be generated in a wireless device from a generic eSIM with limited options for customization of the generated bootstrap eSIM. Fully functional user eSIMs, typically, are downloaded from an MNO provisioning server to an eUICC of a wireless device. There exists a need for mechanisms to generate, at a wireless device, MNO provisioning eSIMs and/or MNO user eSIMs customized for the wireless device in the field from eSIM templates.

### SUMMARY

This application sets forth techniques for dynamically customizing an electronic subscriber identity module (eSIM) for a wireless device using a preset eSIM template. Mobile network operator (MNO) specific eSIM templates can be loaded to an embedded universal integrated circuit card (eUICC) of the wireless device during manufacturing or obtained post-manufacturing from an MNO asset server. An MNO specific eSIM template can include MNO files and data, such as proprietary applets and algorithms, and can be customized to include device specific data in the field.

In some embodiments, an eUICC manufacturer (EUM) loads one or more eSIM templates and rules to an eUICC, which can store the one or more eSIM templates together as a universal eSIM profile. Each eSIM template can map to a specific MNO. In some embodiments, the EUM loads one or more personalization scripts that include transaction identifiers and static session keys for verifying and installing one or more MNO specific eSIM templates after manufacturing. A processor of the wireless device can assist the eUICC to obtain, load, and install an MNO specific eSIM template. In some embodiments, the processor provides to the eUICC an eSIM template from local storage of the wireless device. In some embodiments, the processor provides to the eUICC an eSIM template obtained from an eSIM template asset server. In some embodiments, the eSIM template, which is not yet personalized for the wireless device, is included in a bound profile package (BPP). In some embodiments, the eSIM template is downloaded by the eUICC or the processor from an MNO provisioning server. In some embodiments, an eSIM template is personalized by the eUICC with device specific data applicable for access to cellular wireless services of the MNO, such as an international mobile subscriber identity (IMSI) value and an authentication key (Ki) associated with the IMSI value. In some embodiments, the IMSI value and the Ki are dynamically injected by the eUICC to the eSIM template using a non-access stratum (NAS) authentication protocol when the eSIM template is enabled to be used by the eUICC of the wireless device. In some embodiments, an MNO specific eSIM template includes an MNO specific subscription concealed identifier (SUCI) public key (PK) to use to generate a SUCI for the wireless device. In some embodiments, an MNO specific eSIM template includes one or more proprietary applets or executable code specific to the MNO. In some embodiments, an MNO specific eSIM template includes a proprietary algorithm or algorithmic tuning specific to the MNO.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of exemplary components of the system of FIG. 1, according to some embodiments.

FIG. 3 illustrates a block diagram of an example of loading preset electronic subscriber identity module (eSIM) templates to a wireless device during manufacturing, according to some embodiments.

FIG. 4 illustrates a block diagram of an example of loading present eSIM templates to a wireless device after manufacturing via personalization scripts, according to some embodiments.

FIGS. 5A, 5B, and 5C illustrate an exemplary eSIM template binding flow to customize an eSIM template for a wireless device, according to some embodiments.

FIG. 6 illustrates an example of loading preset eSIM templates to a wireless device after manufacturing via a mobile network operator (MNO) eSIM template asset server, according to some embodiments.

FIGS. 7A and 7B illustrate another exemplary eSIM template binding flow to customize an eSIM template for a wireless device, according to some embodiments.

FIGS. 8A and 8B illustrate an example of dynamic eSIM template personalization for a fifth generation (5G) wireless device, according to some embodiments.

FIG. 9 illustrates an exemplary method for dynamic eSIM customization using an eSIM template by a wireless device, according to some embodiments.

FIG. 10 illustrates another exemplary method for dynamic eSIM customization using an eSIM template by a wireless device, according to some embodiments.

FIG. 11 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

This application sets forth techniques for dynamically customizing an electronic subscriber identity module (eSIM) for a wireless device using a preset eSIM template. Mobile network operator (MNO) specific eSIM templates can be loaded to an embedded universal integrated circuit card (eUICC) of a wireless device during manufacturing or obtained post-manufacturing by the wireless device from an MNO eSIM template asset server. An MNO specific eSIM template can include MNO files and data, e.g., proprietary applets, executable code specific to the MNO, special authentication algorithms, proprietary algorithm tunings, and one or more MNO specific public keys, such as a subscription concealed identifier (SUCI) public key. The MNO specific eSIM template can be customized after (or as part of) installation in the wireless device to include device specific data while the wireless device is operational (or while configuring to be operational) in the field. Static MNO data applicable for a wireless device can be included in an eSIM template, while dynamic device specific data can be injected into the eSIM template to generate a customized eSIM for the wireless device. Customization can occur after delivery of the wireless device to a user.

In some embodiments, an eUICC manufacturer (EUM) loads one or more eSIM templates and rules to an eUICC, which can store the one or more eSIM templates together as a universal eSIM profile. Each eSIM template can map to a specific MNO. In some embodiments, the EUM loads one or more personalization scripts that include transaction identifiers and static session keys for verifying and installing one or more MNO specific eSIM templates after manufacturing. Exemplary personalization scripts can include Secure Channel Protocol Type 3 (SCP03) perso scripts. A processor of the wireless device can assist the eUICC to obtain, load, and install an MNO specific eSIM template. In some embodiments, the processor can be external to the eUICC. In some embodiments, the eUICC and the processor can share processing resources. In some embodiments, the processor provides to the eUICC an eSIM template from local storage of the wireless device. In some embodiments, the processor provides to the eUICC an eSIM template obtained from an eSIM template asset server. In some embodiments, the eSIM template which is not yet personalized for the wireless device, is included in a bound profile package (BPP). In some embodiments, the eSIM template is downloaded by the eUICC or the processor of the wireless device from an MNO provisioning server.

In some embodiments, an eSIM template is personalized by the eUICC with device specific data applicable for access to cellular wireless services of the MNO. Dynamic device specific data can include an international mobile subscriber identity (IMSI) value for a cellular wireless subscription to access cellular wireless services of an MNO and an authentication key (Ki) associated with the IMSI value for authenticating the wireless device with a cellular wireless network of the MNO. In some embodiments, the IMSI value and the Ki are dynamically injected by the eUICC to the eSIM template using a non-access stratum (NAS) authentication protocol when the eSIM template is enabled to be used by the eUICC of the wireless device. In some embodiments, an MNO specific eSIM template includes an MNO specific subscription concealed identifier (SUCI) public key (PK) to use to generate a SUCI for the wireless device. In some embodiments, an MNO specific eSIM template includes a proprietary applet specific to the MNO. In some embodiments, an MNO specific eSIM template includes executable code specific to the MNO. In some embodiments, an MNO specific eSIM template includes a proprietary authentication algorithm, or algorithm tuning, specific to the MNO.

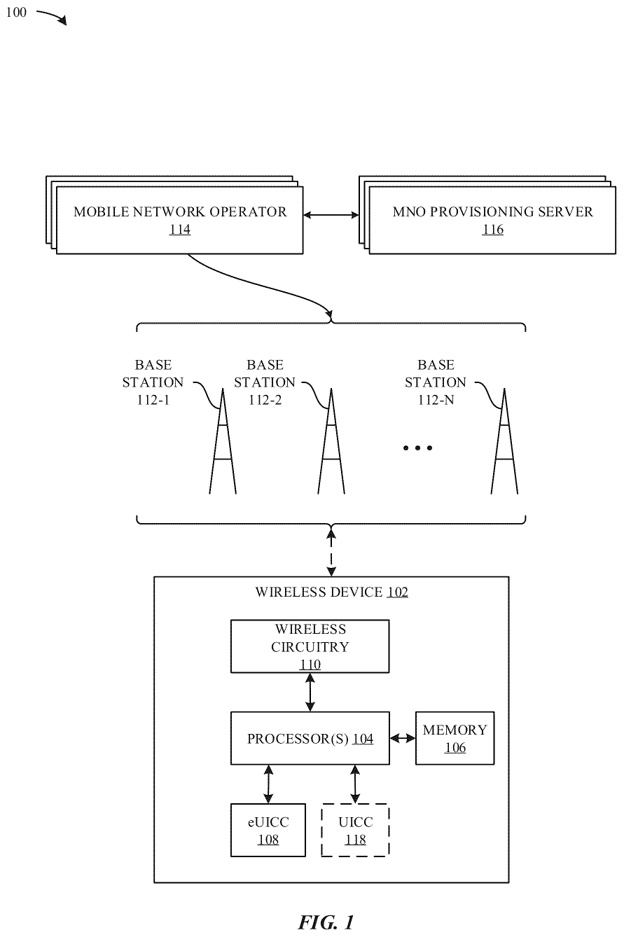

These and other embodiments are discussed below with reference to FIGS. 1-11; however, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a wireless device 102, which can also be referred to as a wireless device, a wireless device, a mobile device, a user equipment (UE) and the like, a group of base stations 112-1 to 112-N that are managed by different Mobile Network Operators (MNOs) 114, and a set of provisioning servers 116 that are in communication with the MNOs 114. Additional MNO infrastructure servers, such as used for account management and billing are not shown. The wireless device 102 can represent a computing device (e.g., an iPhone® or an iPad® by Apple®), the base stations 112-1 to 112-n can represent cellular wireless network entities including evolved NodeBs (eNodeBs or eNBs) and/or next generation NodeBs (gNodeBs or gNB) that are configured to communicate with the wireless device 102, and the MNOs 114 can represent different wireless service providers that provide specific cellular wireless services (e.g., voice and data) to which the wireless device 102 can subscribe, such as via a subscription account for a user of the wireless device 102.

As shown in FIG. 1, the wireless device 102 can include processing circuitry, which can include one or more processor(s) 104 and a memory 106, an embedded Universal Integrated Circuit Card (eUICC) 108, and a baseband wireless circuitry 110 used for transmission and reception of cellular wireless radio frequency signals. The baseband wireless circuitry 110 can include analog hardware components, such as antennas and amplifiers, as well as digital processing components, such as signal processors (and/or general/limited purpose processors) and associated memory. In some embodiments, the wireless device 102 includes one or more physical UICCs 118, also referred to as Subscriber Identity Module (SIM) cards, in addition to or substituting for the eUICC 108. The components of the wireless device 102 work together to enable the wireless device 102 to provide useful features to a user of the wireless device 102, such as cellular wireless network access, non-cellular wireless network access, localized computing, location-based services, and Internet connectivity. The eUICC 108 can be configured to store multiple electronic SIMs (eSIMs) for accessing cellular wireless services provided by different MNOs 114 by connecting to their respective cellular wireless networks through base stations 112-1 to 112-N. For example, the eUICC 108 can be configured to store and manage one or more eSIMs for one or more MNOs 114 for different subscriptions to which the wireless device 102 is associated. To be able to access services provided by an MNO 114, an eSIM can be reserved for subsequent download and installation to the eUICC 108. In some embodiments, the eUICC 108 obtains one or more eSIMs from one or more associated provisioning servers 116 as part of a device initialization of the wireless device 102, such as when purchasing a new wireless device 102. The provisioning servers 116 can be maintained by a manufacturer of the wireless device 102, the MNOs 114, third party entities, and the like. Communication of eSIM data between an MNO provisioning server 116 and the eUICC 108 (or between the MNO provisioning server 116 and processing circuitry of the wireless device 102, e.g., the processor 104) can use a secure communication channel. In some embodiments, the processor 104 can be external to the eUICC 108. In some embodiments, the eUICC 108 and the processor 104 and/or processing circuitry of the wireless device 102 can share processing resources.

In some embodiments, the eUICC 108 of the wireless device 102 includes one or more eSIM templates pre-installed, where each eSIM template can map to a specific MNO 114. In some embodiments, a processor 104 of the wireless device 102 can provide an eSIM template to the eUICC 108, e.g., from local storage of the wireless device or downloaded from a network accessible server. Exemplary network accessible servers can include MNO eSIM template asset servers and/or MNO provisioning servers 116. In some cases, an un-personalized eSIM template can be included in a bound profile package (BPP), and an identical eSIM template BPP, which is not personalized for a specific wireless device, can be downloaded to different wireless devices 102. The eSIM template included in the BPP can be specific to a particular MNO 114 but can be delivered in a generic, un-personalized form that is later customized for the particular wireless device 102. In some cases eSIM template BPPs can be downloaded, managed, and installed on an eUICC 108 of a wireless device 102 using processes similar to those used for eSIMs.

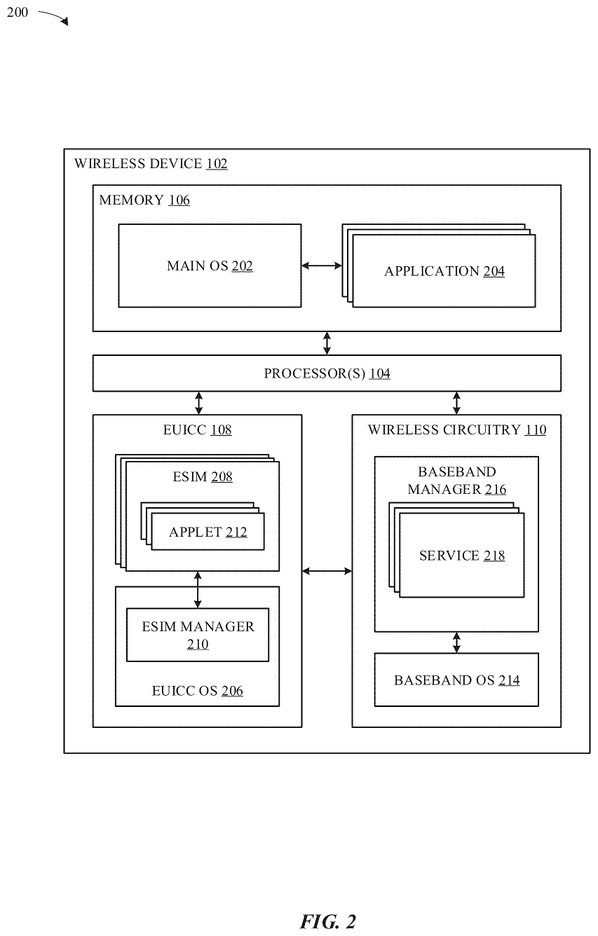

FIG. 2 illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIMs 208 that are stored by the eUICC 108, e.g., by downloading, installing, deleting, enabling, disabling, modifying, or otherwise performing management of the eSIMs 208 within the eUICC 108 and providing baseband wireless circuitry 110 with access to the eSIMs 208 to provide access to wireless services for the wireless device 102. The eUICC 108 OS can include an eSIM manager 210, which can perform management functions for various eSIMs 208. According to the illustration shown in FIG. 2, each eSIM 208 can include a number of applets 212 that define the manner in which the eSIM 208 operates. For example, one or more of the applets 212, when implemented in conjunction with baseband wireless circuitry 110 and the eUICC 108, can be configured to enable the wireless device 102 to communicate with an MNO 114 and provide useful features (e.g., phone calls and internet access) to a user of the wireless device 102.

As also shown in FIG. 2, the baseband wireless circuitry 110 of the wireless device 102 can include a baseband OS 214 that is configured to manage hardware resources of the baseband wireless circuitry 110 (e.g., a processor, a memory, different radio components, etc.). According to some embodiments, the baseband wireless circuitry 110 can implement a baseband manager 216 that is configured to interface with the eUICC 108 to establish a secure channel with an MNO provisioning server 116 and obtaining information (such as eSIM data) from the MNO provisioning server 116 for purposes of managing eSIMs 208. The baseband manager 216 can be configured to implement services 218, which represents a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

As discussed further herein, the eUICC 108 can further include one or more MNO specific eSIM templates, loaded during manufacturing and/or added post-manufacturing. The MNO specific eSIM templates can be customized for the wireless device 102 while the wireless device is in the field. In some cases, a processor 104 of the wireless device 102 assists the eUICC 108 to obtain, manage, customize, and/or install one or more eSIM templates. The eSIM templates can include data and/or files that are specific to an MNO 114 and usable on different wireless devices 102. A customized eSIM template can include data that is specific to the wireless device 102.

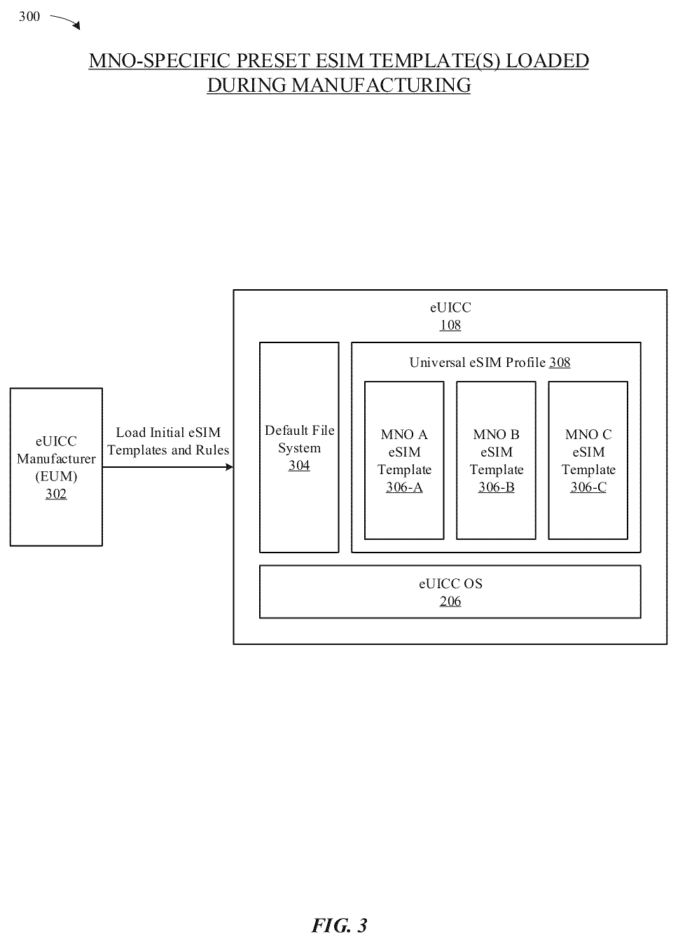

FIG. 3 illustrates a block diagram 300 of an example of loading preset eSIM templates 306 to a wireless device 102 during manufacturing. An eUICC manufacturer (EUM) 302 can load an initial set of one or more eSIM templates and associated rules to an eUICC 108 as part of a manufacturing process for the eUICC 108. For example, one or more eSIM templates 306 can be loaded to the eUICC 108 with an eUICC OS 206 and a default file system 304. In some embodiments, each eSIM template 306 can be associated with a specific MNO 114. In some embodiments, a set of one or more eSIM templates 306 for different MNOs 114, e.g., an MNO A eSIM template 306-A, an MNO B eSIM template 306-B, and an MNO C eSIM template 306-C, can be grouped together as a universal eSIM profile 308. The eSIM templates 306 for each MNO 114 can include an eSIM profile shell and static data specific to the MNO 114, e.g., one or more proprietary applets, executable code specific to the MNO 114, authentication algorithms and/or algorithm tunings preferred for use by the MNO 114, and/or one or more MNO public keys, such as a public key used for generating a SUCI for a wireless device 102. The eSIM templates 306 can include the MNO static data when stored on the eUICC 108 (or when stored locally on the wireless device 102 or at a remote, network accessible server). An eSIM template 306 can be later customized with dynamically with device specific data via a non-access stratum (NAS) authentication protocol. Exemplary device specific data includes an IMSI value for a subscription and associated authentication keys (Ki). In some embodiments, selection of an eSIM template to customize by the eUICC 108 can be based on the device specific data, e.g., a prefix of the IMSI value, such as an mobile country code (MCC) value and a mobile network code (MNC) value for an MNO 114. In some embodiments, selection of the eSIM template to customize can further depend on a global identifier type 1 (GID1) value and/or global identifier type 2 (GID2) value for a mobile virtual network operator (MVNO).

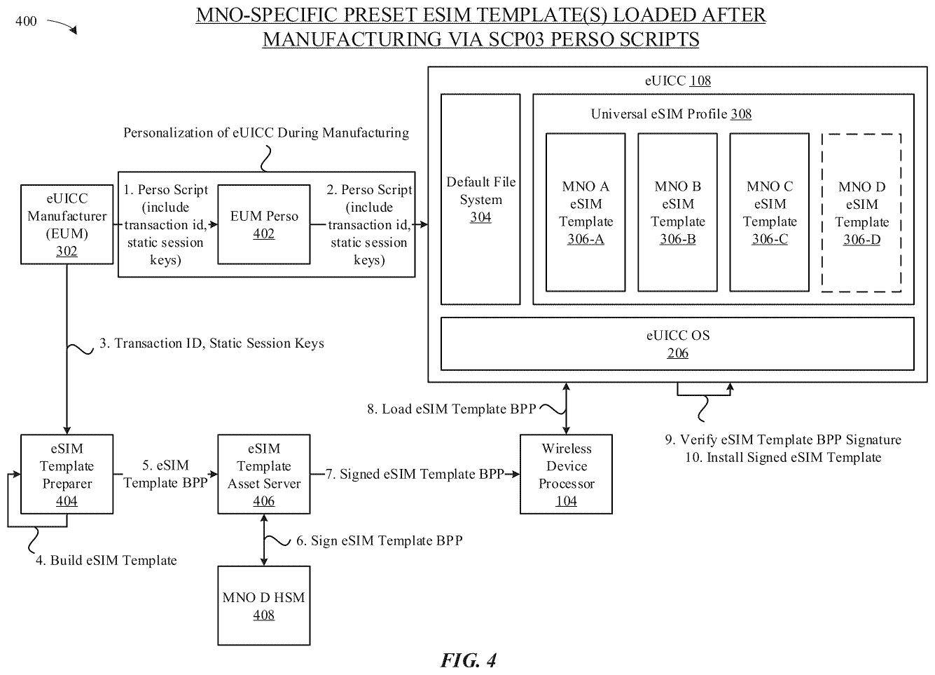

FIG. 4 illustrates a block diagram 400 of an example of loading one or more preset eSIM templates 306 to a wireless device 102 after manufacturing via personalization scripts that are pre-stored in the eUICC 108 of the wireless device 102. An EUM 302 (and/or a device OEM), via an EUM personalization procedure 402, can personalize the eUICC 108 during manufacturing to include one or more personalization scripts, also referred to herein as perso scripts. In some embodiments, the personalization scripts are based on a Global Platform Secure Channel Protocol Type 03 (SCP03) format. Each personalization script can include a transaction identifier and one or more static session keys. Personalization scripts can be customized for different MNOs 114. The EUM 302 can also provide a transaction ID value and static session keys to an eSIM template preparer 404 that can assemble an eSIM template 306 that includes the transaction ID and static session keys in along with eSIM files together in a bound profile package (BPP). The eSIM template BPP can be provided by the eSIM template prepare 404 to an eSIM template asset server 406 that can have the eSIM template BPP signed by an MNO hardware security module (HSM) 408. In the example illustrated in FIG. 4, the eUICC 108 is pre-loaded during manufacturing with eSIM templates 306 from several different MNOs 114, e.g., an MNO A eSIM template 306-A, an MNO B eSIM template 306-B, and an MNO C eSIM template 306-C. After manufacturing of the eUICC 108, e.g., once assembled into a wireless device 102 and delivered from an OEM factory to a user, the eUICC 108 can be updated to include an MNO D eSIM template 306-D obtained by a processor 104 of the wireless device 102 from the eSIM template asset server 406. In some embodiments, the eSIM template asset server 406 is maintained by an MNO 114. In some embodiments, the eSIM template asset server 406 is maintained by an OEM of the wireless device 102. In some embodiments, the eSIM template asset server 406 is maintained by a third party entity affiliated with one or more MNOs 114 and/or with the OEM of the wireless device. The wireless device processor 104 can obtain the signed eSIM template BPP from the eSIM template asset server 406 and load the signed eSIM template BPP to the eUICC 108. The eUICC 108 can verify the eSIM template BPP signature, and after successful verification, the eUICC 108 can install the eSIM template 306-D for MNO D, e.g., as part of the universal eSIM profile 308, using an applicable personalization script previously pre-stored in the eUICC 108.

In some embodiments, one or more generic (not yet customized) eSIM templates 306 are pre-loaded in an eUICC 108 of a wireless device 102, where the eSIM templates 306 include MNO applets 212 and an MNO SUCI public key, and later MNO credentials specific to the wireless device 102, e.g., an IMSI value and associated authentication key (Ki) information, are injected to customize the eSIM template 306 for the wireless device 102. Customization of an eSIM template can occur as part of a NAS attach/authentication procedure. In some embodiments, one or more generic (not yet customized) eSIM templates 306 are stored on memory 106 of the wireless device 102, which in some embodiments can be external to the eUICC 108, and accessible to a processor 104 of the wireless device 102, where an un-personalized eSIM template 306 can be embedded in a bound profile package (BPP). The processor 104 of the wireless device 102 can load an eSIM template 306 to the eUICC 108 with MNO credentials, the IMSI value and associated Ki, to allow the eUICC 108 to customize the eSIM template 306 for the wireless device 102. In some embodiments, an eSIM template BPP can be downloaded from a network accessible server, e.g., an MNO eSIM template asset server and/or an MNO provisioning server 116 and later customized with device specific credentials, e.g., a bootstrap IMSI value and associated Ki. In some embodiments, a generic, un-personalized eSIM template extracted from an eSIM template BPP is customized with device specific credentials, e.g., a bootstrap IMSI value and associated Ki, to generate a bootstrap eSIM profile that is used for a limited functionality connection to an MNO asset server, e.g., an MNO provisioning server 116, to obtain an MNO specific eSIM template BPP. The MNO specific eSIM template BPP can be updated dynamically by a wireless device 102 to include device specific credentials, e.g., a user IMSI value and associated Ki, to generate a customized, fully functional eSIM 208 profile.

In some embodiments, an MNO specific eSIM template 306 is pre-loaded to an eUICC 108 of a wireless device 102 using a Global Platform Secure Channel Protocol Type 03 (SCP03) personalization (perso) script. The procedure can be proprietary to an MNO 114 and can be developed collaboratively by the MNO 114 with an EUM 302 of the eUICC 108 and/or with an original equipment manufacturer (OEM) of the wireless device 102. MNO specific eSIM templates 306 can reside within a universal eSIM profile 308 that is managed by an applet 212 of the eUICC 108 (e.g., as part of the eUICC OS 206.

In some embodiments, an MNO eSIM template BPP that includes an MNO-specific, un-personalized (device agnostic) eSIM template 306, can be downloaded on demand from an MNO asset server, such as an MNO provisioning server 116, and installed on an eUICC 108 using a procedure similar to that used for fully functional eSIM profiles 208. In some embodiments, dynamic device specific data, such as an IMSI value and associated Ki, and merged into an MNO eSIM template 306 by an eUICC 108 when enabling the eSIM template 306 to generate a fully functional eSIM 208.

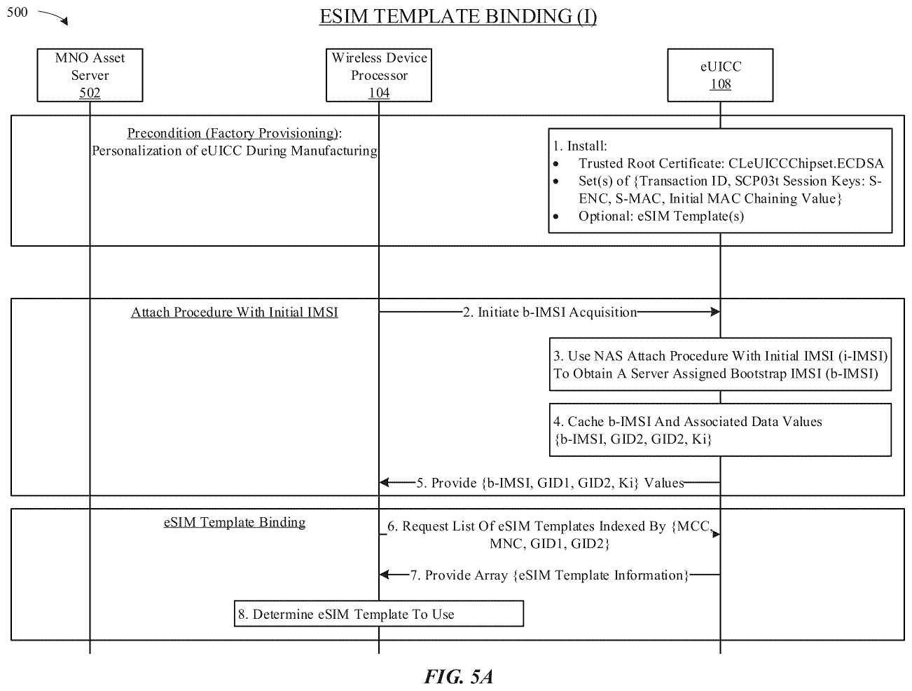

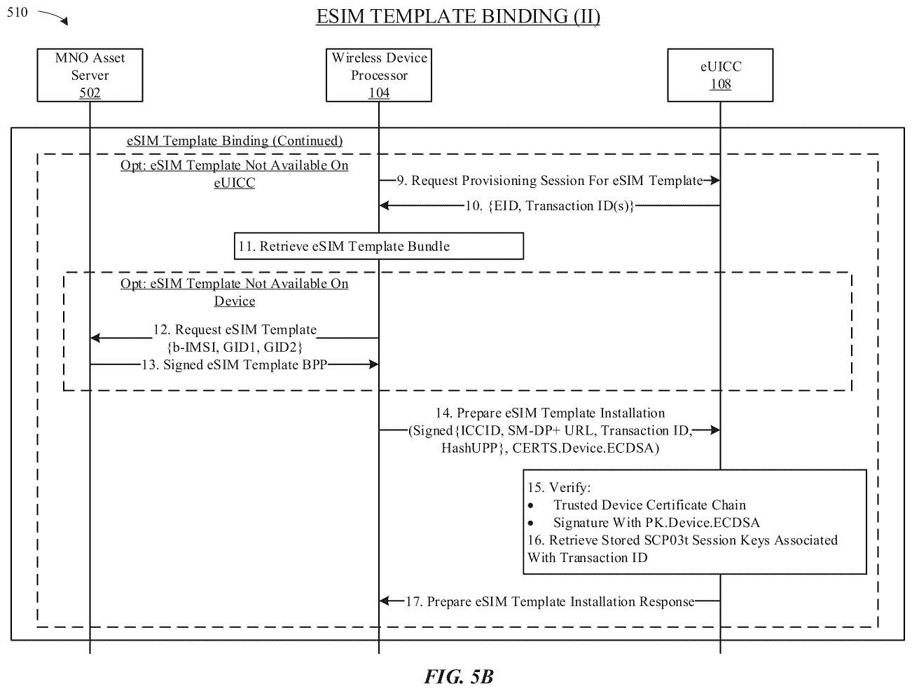

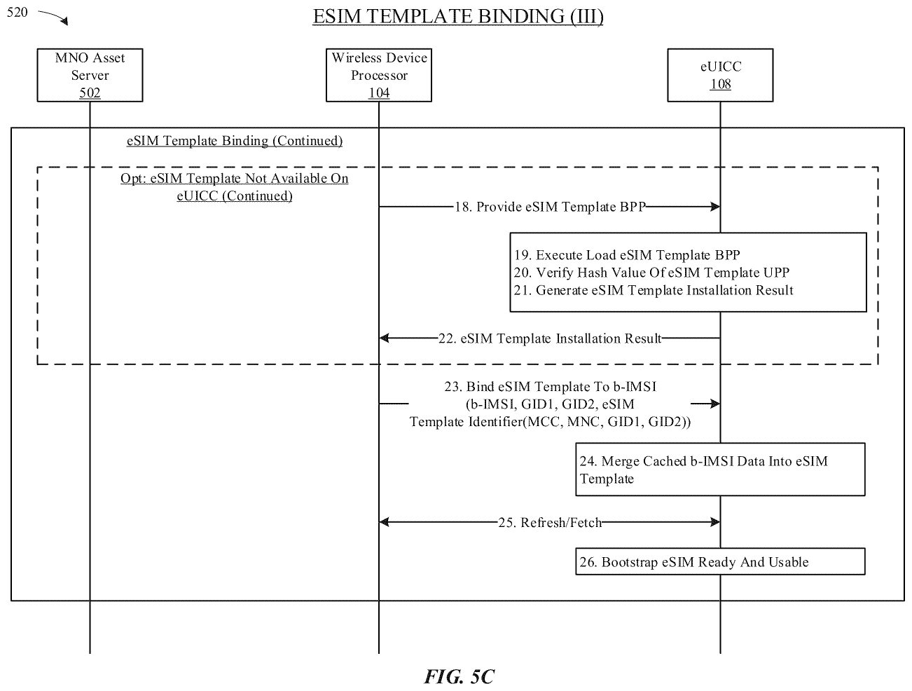

FIGS. 5A, 5B, and 5C illustrate diagrams 500, 510, 520 of an exemplary eSIM template binding flow to customize an eSIM template 306 for a wireless device 102. Initially, the eUICC 108 of the wireless device 102 can be personalized during manufacturing, e.g., provisioned with data files at an EUM 302 and/or at an OEM factory of the wireless device 102. A trusted root certificate, e.g., CLeUICCChipset.ECDSA, can be installed for verification and/or authentication purposes. One or more sets of data associated with (and/or as part of) personalization scripts, e.g., e.g., transaction ID values paired with SPC03t session keys (S-ENC, S-MAC, Initial MAC Chaining Value), can be installed in the eUICC 108. The personalization scripts can be used to later install and/or personalize an eSIM template 306 for the eUICC 108. Optionally, one or more eSIM templates 306 can be pre-installed in the eUICC 108 for later customization.

After manufacturing and delivery of the wireless device 102 to a user, an eSIM template 306 can be customized for the wireless device 102. The eSIM template 306 can be already installed in the eUICC 108 or added to the eUICC 108. Customization can include binding the eSIM template associated with an MNO 114 with device specific information obtained from an MNO network based server. In some cases, the eSIM template 306 is customized to generate a limited functionality bootstrap eSIM 208. In some cases, the eSIM template 306 is customized to generate a fully functional user eSIM 208. In the example shown in FIGS. 5A, 5B, and 5C, the eSIM template 306 is being customized to generate a bootstrap eSIM 208, however a substantially similar process can be used to generate a user eSIM 208. A wireless device processor 104 can send a command to the eUICC 108 to initiate acquisition of a bootstrap IMSI (b-IMSI) value. The eUICC 108 can perform a non-access stratum (NAS) attach procedure, using an initial IMSI (i-IMSI) value pre-stored in the eUICC 108, and obtain from an MNO network server a b-IMSI value assigned by the MNO network server to the eUICC 108 of the wireless device 102. The eUICC 108 can cache the b-IMSI value and additional associated data values obtained from the MNO network server, e.g., GID1 and GID2 values (if applicable) and authentication key Ki values associated with the b-IMSI value. The eUICC 108 can cached the set of values {b-IMSI, GID1, GID2, Ki} for later usage and can also provide the set of values {b-IMSI, GID1, GID2, Ki} to the wireless device processor 104.

The b-IMSI value (and GID1, GID2 values if applicable) is specific to a particular MNO (or MVNO), and can be used to determine whether an eSIM template 306 for the MNO (or MVNO) is already present in the eUICC 108 or needs to be installed in the eUICC 108. The wireless device processor 104 can send a message to the eUICC 108 requesting a list of eSIM templates 306 that are available in the eUICC 108. In some cases, the list of eSIM templates 306 can be indexed based on a prefix of the b-IMSI value, e.g., the MCC and MNC values of the b-IMSI value, as well as GID values if applicable. The eUICC 108 can respond to the wireless device processor 104 with an array that includes information regarding eSIM templates 306 available in the eUICC 108. In some embodiments, the array also includes information for eSIM templates 306 that are available to be uploaded to the eUICC 108 and/or downloadable from one or more network-based servers. The wireless device processor 104 can determine a particular eSIM template 306 to use for binding with the b-IMSI value.

When the eSIM template 306 selected for binding is not available in the eUICC 108, the wireless device processor 104 can assist the eUICC 108 to obtain and install the selected eSIM template 306. In some cases, the selected eSIM template 306 can be available in local storage of the wireless device 102. In some cases, the selected eSIM template 306 can be obtained from remote storage, e.g., from a network-based server. The wireless device processor 104 can send a message to the eUICC 108 to request a provisioning session for the selected eSIM template 306. The eUICC 108 can return an eUICC identifier (EID) value and one or more transaction ID values to the wireless device processor 104. When the eSIM template 306 is available in local storage of the wireless device 102, the wireless device processor 104 can retrieve an eSIM template bundle (e.g., an eSIM template BPP) from local storage. When the eSIM template 306 is not available on the wireless device 102, the wireless device processor 104 can send a message to an MNO asset server 502 requesting the eSIM template 306. The message can include relevant identifier information, e.g., the b-IMSI value and GID1, GID2 values, if applicable. The MNO asset server 502 can return to the wireless device processor 104 a BPP that includes the un-personalized eSIM template 306 and is also signed by the MNO, e.g., as indicated in FIG. 4 where the eSIM template BPP is signed by an MNO HSM 408.

After obtaining the eSIM template bundle/BPP (either from local storage or from a remote MNO network server), the wireless device processor 104 can perform a procedure with the eUICC 108 to verify the eSIM template bundle/BPP prior to installation of the eSIM template 306 on the eUICC 108. The wireless device process can send a message to the eUICC 108 to prepare for installation of an eSIM template 306. The message can include information to allow the eUICC 108 to perform verification prior to installing the eSIM template 306. The message can include a set of values {ICCID, SM-DP+ URL, Transaction ID, HashUPP} signed by the wireless device processor 104 accompanied by a device certificate CERTS.Device.ECDSA, where the HashUPP is a hash value for an unprotected profile package (UPP) within the eSIM template BPP. The ICCID value can indicate the eSIM template 306. The SM-DP+ URL value can indicate the endpoint that the wireless device 102 is using to avoid “man-in-the-middle” attacks. The eUICC 108 can verify the message received from the wireless device processor 104 to ensure that the wireless device processor 104 can be trusted using the embedded device certificate from the message and a public key of the device PK.Device.ECDSA. After successful verification, the eUICC 108 can retrieve personalization script information previously installed in the eUICC 108, e.g., one or more SCP03t session keys associated with the transaction ID included in the message from the wireless device processor 104. Subsequently, the eUICC 108 can provide to the wireless device processor 104 an applicable response to the prepare eSIM template installation message indicating whether verification is successful and the eSIM template installation procedure can continue.

The wireless device processor 104 can provide the eSIM template BPP to the eUICC 108, which can execute an applicable procedure, e.g., using an personalization script, to load the eSIM template BPP, verify the hash value of the eSIM template UPP, and after successful verification load the un-personalized eSIM template 306 extracted from the eSIM template BPP/UPP to memory of the eUICC 108. The eUICC 108 can generate an eSIM template installation result indicating whether the eSIM template 306 was successfully installed and provide the eSIM template installation result to the wireless device processor 104. The eSIM template 306 installed can still be not yet personalized for the wireless device 102. The wireless device processor 104 can send a binding command to the eUICC 108 to bind the eSIM template 306 to the b-IMSI value. The binding command can include the b-IMSI value, GID values (if applicable, and an eSIM template identifier value, which can be a combination of the MCC and MNC values of the b-IMSI and optional GID values. The eUICC 108 can merge previously cached b-IMSI data into the eSIM template 306 to customize the eSIM template for the wireless device 102, generating a device specific bootstrap eSIM 208. The eUICC 108 can send to the wireless device processor 104 a refresh command, and the wireless device processor 104 can send a fetch command to the eUICC 108 to determine the updated state of the eSIM template 306 on the eUICC 108. After successful personalization of the eSIM template 306 to include the device specific information, a bootstrap eSIM 208 applicable for the wireless device 102 is available for use to connect to a cellular wireless network of an MNO 114 associated with the bootstrap eSIM 208 generated from the eSIM template 306. While the process illustrated in FIGS. 5A, 5B, and 5C is for generating a bootstrap eSIM 208 from an eSIM template 306, the same process (or one that is substantially similar) can be used to generate a user eSIM 208 from an eSIM template 306.

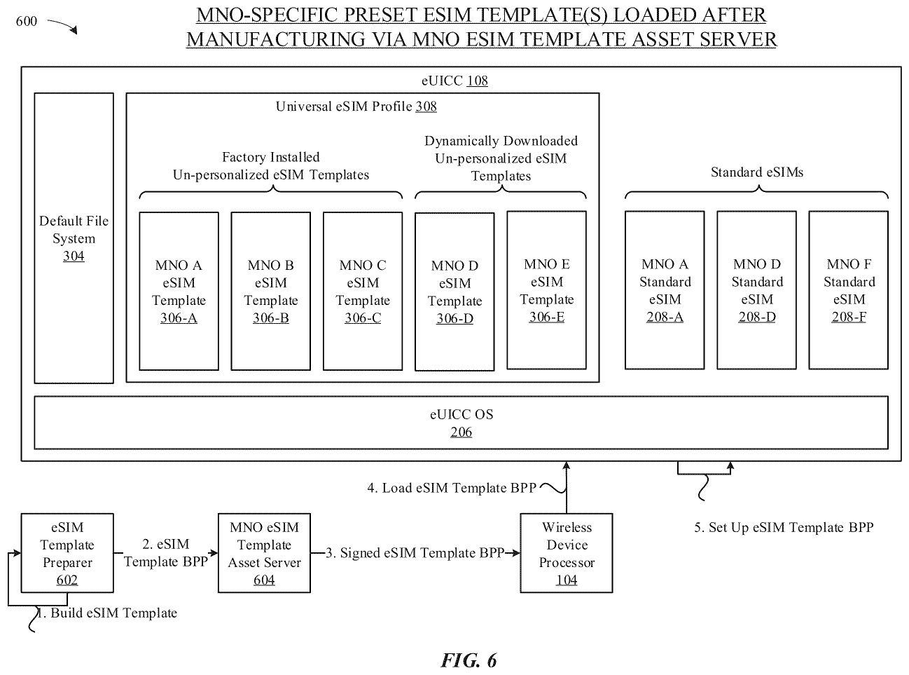

FIG. 6 illustrates a diagram 600 of an example of loading MNO-specific present eSIM template(s) 306 to an eUICC 108 after manufacturing via an MNO eSIM template asset server 604. The eUICC 108 can be configured during manufacturing with a set of factory installed un-personalized eSIM templates, e.g., an MNO A eSIM template 306-A, an MNO B eSIM template 306-B, and an MNO C eSIM template 306-C. The eSIM templates 306 can be stored together as part of a universal eSIM profile 308. The eUICC 108 can be configured after manufacturing with additional, dynamically downloaded, un-personalized eSIM templates, e.g., an MNO D eSIM template 306-D and an MNO E eSIM template 306-E.

An eSIM template preparer 602 can assemble an eSIM template 306 for an MNO 114 and provide the MNO-specific, device-agnostic (un-personalized) eSIM template 306 in a BPP that is stored at an MNO eSIM template asset server 604. A processor 104 of the wireless device 102 can communicate with and obtain from the MNO eSIM template asset server 604 an eSIM template BPP signed by an MNO HSM 408. The wireless device processor 104 can load the eSIM template BPP to the eUICC 108, which can execute a procedure to set up and install the un-personalized eSIM template 306 (extracted from the eSIM template BPP) on memory of the eUICC 108. In some embodiments, the un-personalized eSIM template 306 can be installed in a universal eSIM profile 308 on the eUICC 108. The eUICC 108 can include additional “standard” eSIMs 208, such as MNO A standard eSIM 208-A, MNO D standard eSIM 208-D, and MNO standard eSIM 208-F. In some cases, the MNO A standard eSIM 208-A can be generated by customizing the MNO A eSIM template 306-A pre-installed in the eUICC 108 during manufacturing. In some cases, the MNO D standard eSIM 208-D can be generated by customizing the MNO D eSIM template 306-D dynamically downloaded and installed in the eUICC 108 after manufacturing. In some cases, the MNO F standard eSIM 208-F can be downloaded from an MNO provisioning server 116 and installed on the eUICC 108 (or pre-installed in the eUICC 108 during manufacturing), and there may be no corresponding eSIM template 306 stored on the eUICC 108.

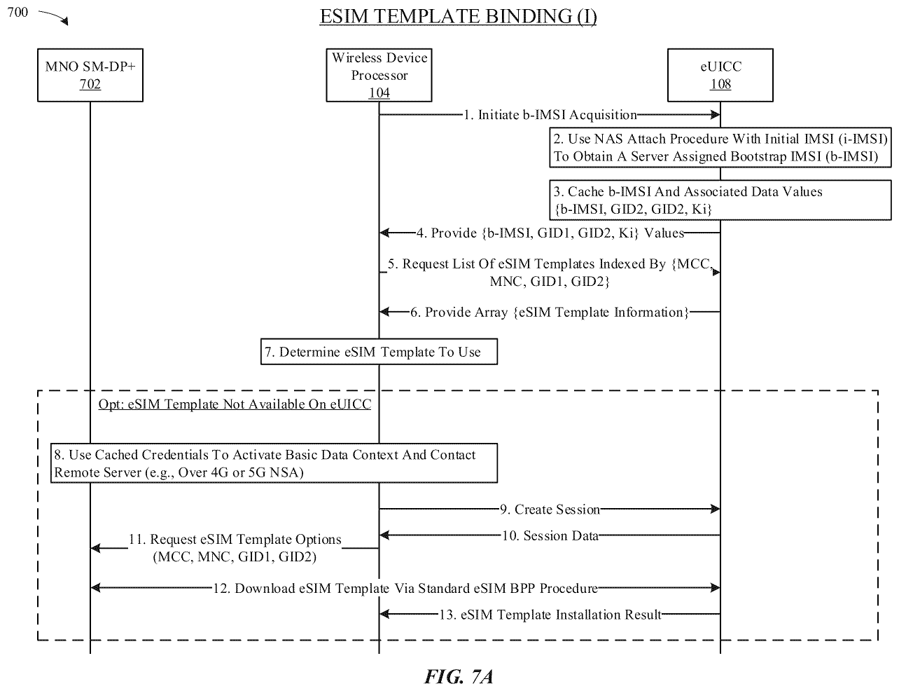

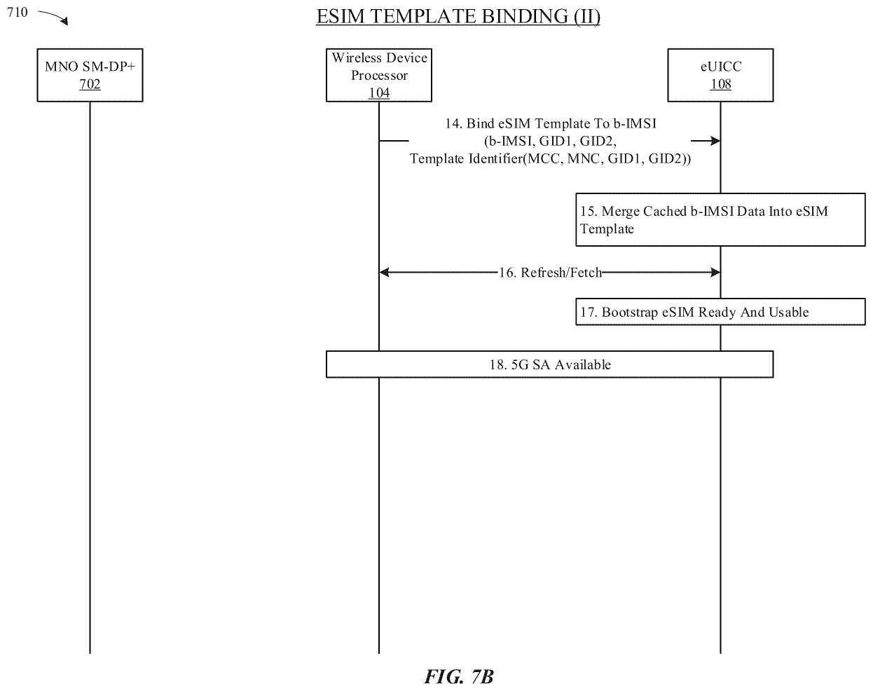

FIGS. 7A and 7B illustrate diagrams 700, 710, of another exemplary eSIM template 306 binding flow to customize an eSIM template 306 for a wireless device 102. In the binding flow illustrated in FIGS. 5A, 5B, and 5C, a personalization script was used as part of the eSIM template 306 customization procedure, while the binding flow shown in FIGS. 7A and 7B does not use a personalization script. A wireless device processor 104 can send a command to the eUICC 108 to initiate acquisition of a bootstrap IMSI (b-IMSI) value. The eUICC 108 can perform a non-access stratum (NAS) attach procedure, using an initial IMSI (i-IMSI) value pre-stored in the eUICC 108, and obtain from an MNO network server a b-IMSI value assigned by the MNO network server to the eUICC 108 of the wireless device 102. The eUICC 108 can cache the b-IMSI value and additional associated data values obtained from the MNO network server, e.g., GID1 and GID2 values (if applicable) and authentication key Ki values associated with the b-IMSI value. The eUICC 108 can cached the set of values {b-IMSI, GID1, GID2, Ki} for later usage and can also provide the set of values {b-IMSI, GID1, GID2, Ki} to the wireless device processor 104.

The b-IMSI value (and GID1, GID2 values if applicable) is specific to a particular MNO (or MVNO), and can be used to determine whether an eSIM template 306 for the MNO (or MVNO) is already present in the eUICC 108 or needs to be installed in the eUICC 108. The wireless device processor 104 can send a message to the eUICC 108 requesting a list of eSIM templates 306 that are available in the eUICC 108. In some cases, the list of eSIM templates 306 can be indexed based on a prefix of the b-IMSI value, e.g., the MCC and MNC values of the b-IMSI value, as well as GID values if applicable. The eUICC 108 can respond to the wireless device processor 104 with an array that includes information regarding eSIM templates 306 available in the eUICC 108. In some embodiments, the array also includes information for eSIM templates 306 that are available to be uploaded to the eUICC 108 and/or downloadable from one or more network-based servers. The wireless device processor 104 can determine a particular eSIM template 306 to use for binding with the b-IMSI value.

When the eSIM template 306 selected for binding is not available in the eUICC 108, the wireless device processor 104 can assist the eUICC 108 to obtain and install the selected eSIM template 306. In the example of FIGS. 7A and 7B, a MNO specific eSIM template 306 is obtained from an MNO provisioning server 116, e.g., an MNO SM-DP+ 702. The wireless device processor 104 can use cached credentials to activate a basic data context and contact the MNO SM-DP+ 705 via a 4G or 5G non-standalone (NSA) connection. The wireless device processor can establish a provisioning session with the eUICC 108 to obtain and install the eSIM template 306. The eUICC 108 can provide session data. The wireless device processor 104 can send a request message to the MNO SM-DP+ 702 to obtain options for eSIM templates 306 available for downloading and installing to the eUICC 108. The request message can include identifier values for the MNO 114 (and optionally for an MVNO, GID values). The wireless device processor 104 and eUICC 108 can communicate with the MNO SM-DP+ 702 to download an applicable eSIM template 306 BPP associated with the specified identifier values for the MNO 114. In some embodiments, the downloading and installation of the eSIM template 306 BPP can use a standardized procedure as for downloading and installing an eSIM 208 BPP. The eUICC 108 can provide to the wireless device processor 104 an indication of the result of installation of the eSIM template 306 on the eUICC 108. The eSIM template 306 installed can still be not yet personalized for the wireless device 102. The wireless device processor 104 can send a binding command to the eUICC 108 to bind the eSIM template 306 to the b-IMSI value. The binding command can include the b-IMSI value, GID values (if applicable, and an eSIM template identifier value, which can be a combination of the MCC and MNC values of the b-IMSI and optional GID values. The eUICC 108 can merge previously cached b-IMSI data into the eSIM template 306 to customize the eSIM template for the wireless device 102, generating a device specific bootstrap eSIM 208. The eUICC 108 can send to the wireless device processor 104 a refresh command, and the wireless device processor 104 can send a fetch command to the eUICC 108 to determine the updated state of the eSIM template 306 on the eUICC 108. After successful personalization of the eSIM template 306 to include the device specific information, a bootstrap eSIM 208 applicable for the wireless device 102 is available for use to connect to a cellular wireless network of an MNO 114 associated with the bootstrap eSIM 208 generated from the eSIM template 306. In some embodiments, the eSIM template 306 included an MNO SUCI public key (PK) that can be used for encryption and concealment of a user's IMSI value. In some embodiments, the wireless device 102 can be configured to require use of a SUCI when communicating via a 5G standalone (SA) cellular wireless network. Customization of an eSIM template that includes the SUCI PK can allow for access to a 5G SA network (as compared to earlier in the procedure when a 4G or 5G NSA network was used for access). While the process illustrated in FIGS. 7A and 7B is for generating a bootstrap eSIM 208 from an eSIM template 306, the same process (or one that is substantially similar) can be used to generate a user eSIM 208 from an eSIM template 306.

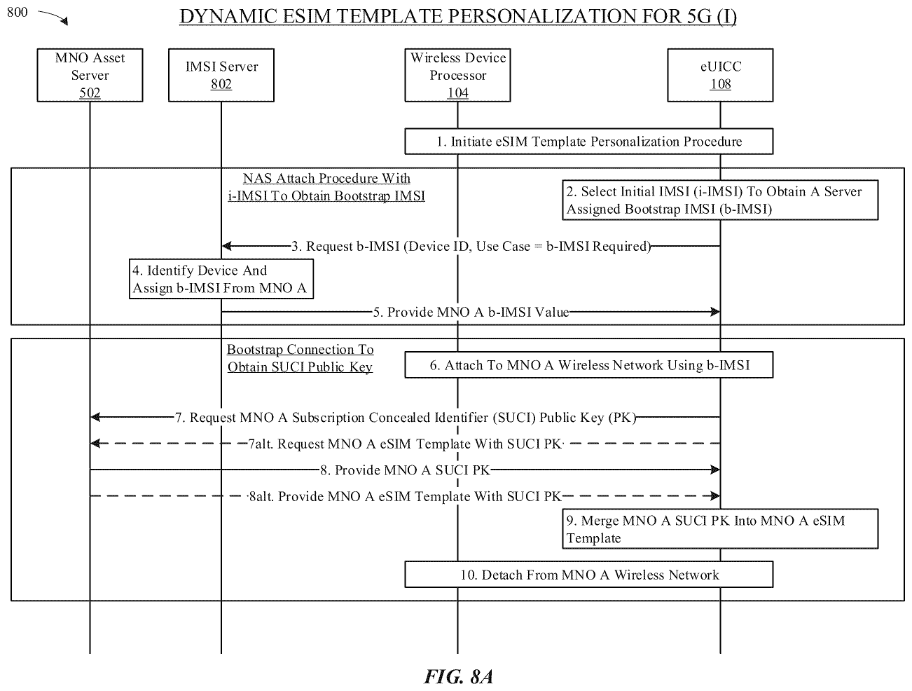

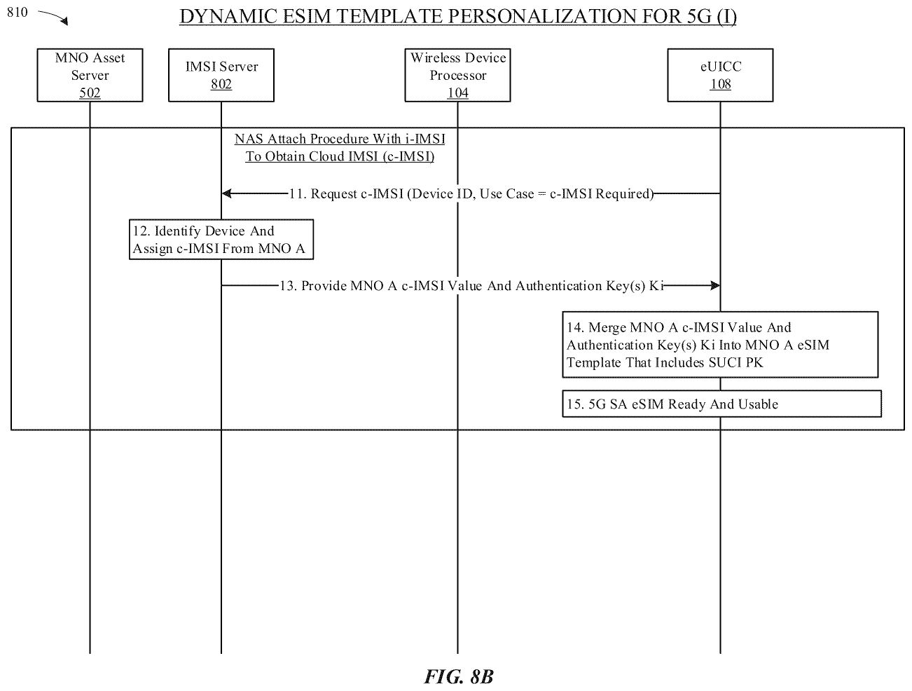

FIGS. 8A and 8B illustrates diagrams 800, 810 of an example of dynamic eSIM template 306 personalization for a fifth generation (5G) wireless device 102. The wireless device processor 104 can initiate the eSIM template 306 personalization procedure with the eUICC 108 of the wireless device 102. The eUICC 108 can select an initial IMSI (i-IMSI) with which to obtain a server assigned bootstrap IMSI (b-IMSI) value. The eUICC 108 can perform a non-access stratum (NAS) attach procedure, using the selected i-IMSI value pre-stored in the eUICC 108, and request a b-IMSI value from an IMSI server 802. In some embodiments, the IMSI server 802 is maintained by an MNO 114 and is specific to an MNO 114. In some embodiments, the IMSI server 802 is maintained by a third party, e.g., an OEM manufacturer or another service, and provides IMSI values for multiple MNOs 114. The request message from the eUICC 108 can include a device identifier (ID) value that uniquely identifies the wireless device 102 and an indication that a b-IMSI value is required. The IMSI server 802 can identify the wireless device 102, e.g., using the included device ID value, and can assign a b-IMSI value for the wireless device 102 applicable for use with a particular MNO 114, e.g., MNO A. The IMSI server 802 can then provide to the eUICC 108 of the wireless device 102 the b-IMSI value for MNO A.

The wireless device processor 104 and the eUICC 108 can use the b-IMSI value to establish a limited functionality bootstrap connection to a cellular wireless network of MNO A. The eUICC 108 can send a request message to an MNO asset server 502 accessible via the bootstrap connection to obtain a SUCI public key (PK) applicable for use with MNO A. In some embodiments, the wireless device processor and/or the eUICC 108 can request an eSIM template 306, applicable for MNO A, where the eSIM template 306 includes a SUCI PK included in the MNO A data of the eSIM template 306. The MNO asset server 502 can provide the MNO A SUCI PK (or optionally an MNO A eSIM template 306 that includes the SUCI PK) to the eUICC 108. The eUICC 108 can personalize an MNO A eSIM template 306 with the SUCI PK. Subsequently, the wireless device processor 104 and the eUICC 108 can detach the wireless device 102 from the MNO A cellular wireless network by closing the bootstrap connection. The b-IMSI value is used for the bootstrap connection to obtain the MNO A SUCI PK (and/or an eSIM template for MNO A that includes the SUCI PK) and can be discarded afterward.

The eUICC 108 can subsequently perform another NAS attach procedure, using the previously selected (and used) i-IMSI value, and request a semi-permanent cloud IMSI (c-IMSI) value from the IMSI server 802. The c-IMSI value can be used with the SUCI PK for access to a 5G SA cellular wireless network with increased security and privacy (as the c-IMSI value will be only used in an encrypted form and not in an unencrypted form as occurred with the b-IMSI value). The request message to the IMSI server 802 can include the device ID value and an indication that a c-IMSI value is required by the wireless device 102. The IMSI server 802 can identify the wireless device 102, e.g., using the included device ID value, and can assign a c-IMSI value for the wireless device 102 applicable for use with MNO A. The IMSI server 802 can then provide to the eUICC 108 of the wireless device 102 the c-IMSI value for MNO A. The eUICC 108 can merge the MNO A c-IMSI value and associated authentication keys Ki into an eSIM template 306 for MNO A that includes the eSIM template 306 also includes the SUCI PK, thereby generating in a customized eSIM 208 usable with a 5G SA cellular wireless network associated with MNO A.

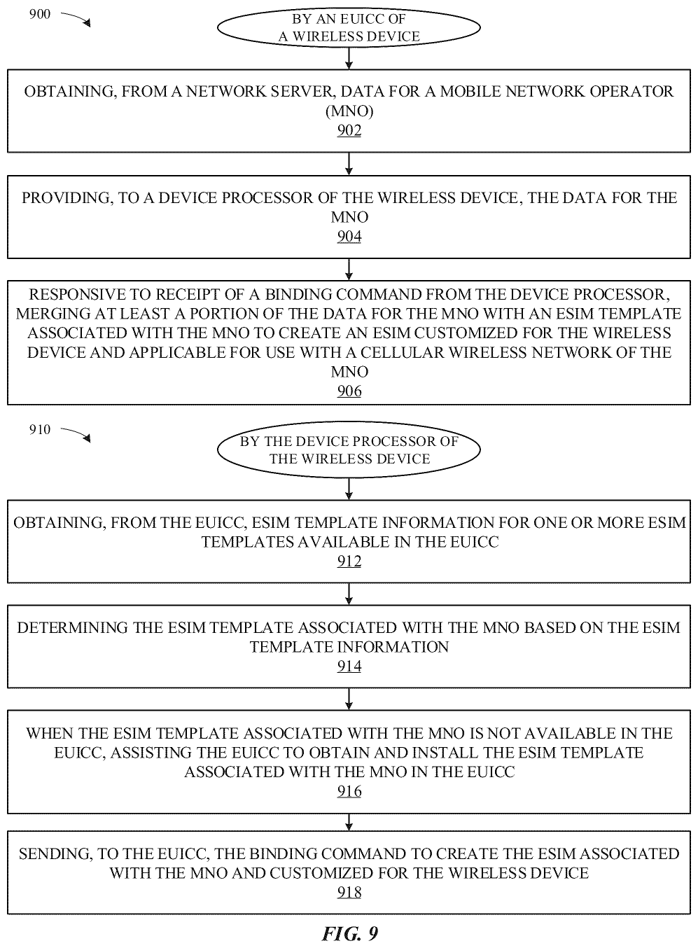

FIG. 9 illustrates flow charts 900, 910 of an exemplary method for dynamic customization of an eSIM 208 associated with an MNO 114, the method performed by an eUICC 108 of a wireless device 102 and by a device processor 104 of the wireless device 102 respectively. At 902, the eUICC 108 of the wireless device 102, obtains, from a network server, data for the MNO 114. In some embodiments, the data for the MNO 114 specifies the MNO 114 uniquely. At 904, the eUICC 108 of the wireless device 102, provides the data for the MNO 114 to the device processor 104 of the wireless device 102. In some embodiments, the processor 104 can be external to the eUICC 108. In some embodiments, the eUICC 108 and the processor 104 and/or processing circuitry of the wireless device 102 can share processing resources. At 906, the eUICC 108 of the wireless device 102, responsive to receipt of a binding command from the device processor 104, merges at least a portion of the data for the MNO 114 with an eSIM template 306 associated with the MNO 114 to create an eSIM 208 customized for the wireless device 102 and applicable for use with a cellular wireless network of the MNO 114. At 912, the device processor 104 of the wireless device 102, obtains, from the eUICC 108, eSIM template information for one or more eSIM templates 306 available in the eUICC 108. At 914, the device processor 104, determines the eSIM template 306 associated with the MNO 114 and to be customized by the eUICC 108 based on the eSIM template information. At 916, when the eSIM template 306 associated with the MNO 114 is not available in the eUICC 108, the device processor 104 assists the eUICC 108 to obtain and install the eSIM template 306 associated with the MNO 114 in the eUICC 108. At 918, the device processor 104 sends, to the eUICC 108, the binding command to create the eSIM 208 associated with the MNO 114 and customized for the wireless device 102.

In some embodiments, the at least a portion of the data merged with the eSIM template 306 includes an IMSI value associated with the MNO 114. In some embodiments, the at least a portion of the data includes a GID1 value and a GID2 value, and the MNO 114 includes an MVNO. In some embodiments, the at least a portion of the data includes an authentication key Ki associated with the IMSI value. In some embodiments, the eSIM template information includes a list of eSIM templates 306 indexed by at least one of: an MCC value, an MNC value, a GID1 value, or a GID2 value. In some embodiments, the device processor 104 assists the eUICC 108 to obtain and install the eSIM template 306 associated with the MNO 114 by at least: i) retrieving an eSIM template 306 BPP associated with the MNO 114 from local storage of the wireless device 102, and ii) providing the eSIM template 306 BPP to the eUICC 108. In some embodiments, the device processor 104 assists the eUICC 108 to obtain and install the eSIM template 306 associated with the MNO 114 by at least: i) sending, to an asset server 502 associated with the MNO 114, a message requesting the eSIM template 306, the message including one or more identifiers for the MNO 114, and ii) receiving, from the asset server 502 associated with the MNO 114, an eSIM template 306 BPP that includes the eSIM template 306 associated with the MNO 114 In some embodiments, the device processor 104 and the eUICC 108 obtain and install the eSIM template 306 by having the device processor 104 establish a data connection to a provisioning server 116, 702 associated with the MNO 114, and by having the eUICC 108: i) download, from the provisioning server 116, 702, an eSIM template 306 BPP that includes the eSIM template 306 associated with the MNO 114, and ii) installing, on the eUICC 108, the eSIM template 306 extracted from the eSIM template 306 BPP. The eSIM template 306, extracted from the eSIM template 306 BPP, can be specific to a particular MNO 114 and can be generic (not specific to a particular wireless device 102) before personalization for the wireless device 102.

In some embodiments, the method further includes the eUICC 108: i) executing a secure channel protocol (SCP) script, pre-installed in the eUICC 108 during manufacturing, to verify an eSIM template 306 unprotected profile package (UPP) extracted from an eSIM template 306 bound profile package (BPP) received from the device processor 104, and ii) installing the eSIM template 306 from the eSIM template 306 UPP after successful verification. In some embodiments, the data for the MNO 114 includes a bootstrap IMSI (b-IMSI) value associated with the MNO 114, and the eUICC 108 obtains the data for the MNO 114 from the network server as part of a non-access stratum (NAS) attach procedure that uses an initial (i-IMSI) value pre-installed in the eUICC 108 during manufacturing. In some embodiments, the eSIM template 306 for the MNO 114 includes a proprietary applet 212 specific to the MNO 114. In some embodiments, the eSIM template 306 for the MNO 114 includes executable code specific to the MNO 114. In some embodiments, the eSIM template 306 for the MNO 114 includes a proprietary algorithm and/or algorithm tuning specific to the MNO 114. In some embodiments, the eSIM template 306 for the MNO 114 includes a public key specific to the MNO 114 to use to generate a subscription concealed identifier (SUCI) for the wireless device 102. In some embodiments, the device processor 104 determines the eSIM template 306 associated with the MNO 114 based on the eSIM template 306 information by at least selecting the eSIM template 306 from multiple eSIM templates 306 stored in the eUICC 108, where each eSIM template 306 of the multiple eSIM templates 306 maps to a specific MNO 114. In some embodiments, the customized eSIM 208 generated from the eSIM template 306 is a limited functionality, bootstrap eSIM 208 suitable for obtaining a full functionality user eSIM 208 from a provisioning server 116, 702 of the MNO 114. In some embodiments, the customized eSIM 208 generated from the eSIM template 306 is a full functionality user eSIM 208 for accessing cellular wireless service of the MNO 114.

In some embodiments, a method for dynamic customization of an eSIM 208 associated with an MNO 114 by a wireless device 102 includes: i) establishing a limited functionality bootstrap connection to an IMSI server 802 using an initial IMSI (i-IMSI) value pre-installed in the wireless device 102 during manufacturing, ii) obtaining, from the IMSI server 802, a bootstrap IMSI (b-IMSI) value applicable for the MNO 114, iii) establishing a second limited functionality bootstrap connection to an asset server 502 associated with the MNO 114 using the b-IMSI value, iv) obtaining, from the asset server 502 associated with the MNO 114, a subscription concealed identifier (SUCI) public key (PK) for encrypting an IMSI of the wireless device 102 associated with the MNO 114, and v) merging the SUCI PK into an eSIM template 306 associated with the MNO 114 to generate an eSIM 208 customized for the wireless device 102 and applicable for use with a cellular wireless network of the MNO 114.

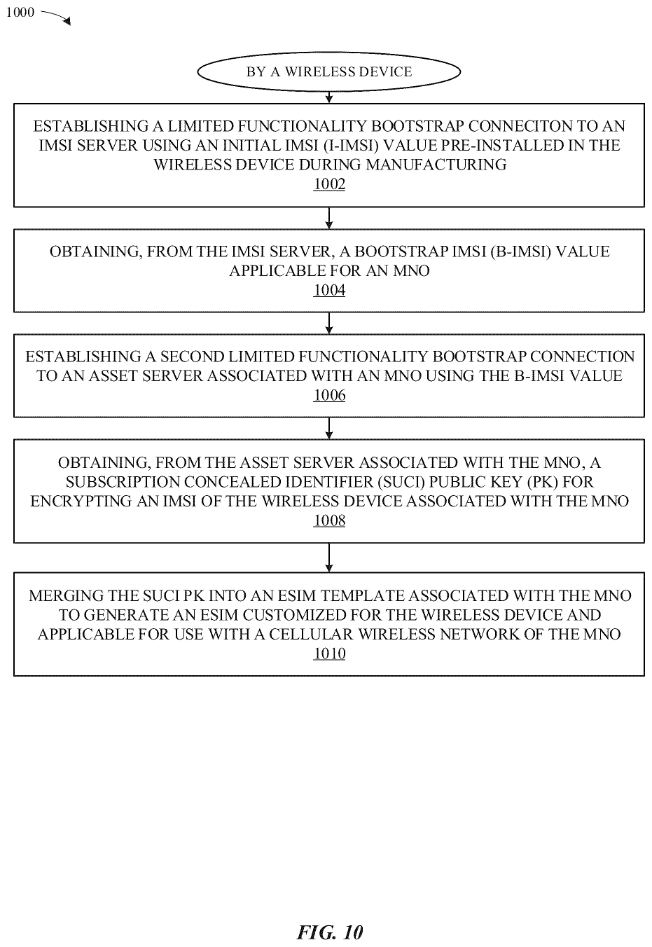

FIG. 10 illustrates a flowchart 1000 of another exemplary method for dynamic eSIM customization using an eSIM template 306 by a wireless device 102. At 1002, the wireless device 102 establishes a limited functionality bootstrap connection to an IMSI server 802 using an initial IMSI (i-IMSI) value pre-installed in the wireless device 102 during manufacturing. At 1004, the wireless device 102 obtains, from the IMSI server 802, a bootstrap IMSI (b-IMSI) value applicable for an MNO 114. At 1006, the wireless device 102 establishes a second limited functionality bootstrap connection to an asset server 502 associated with the MNO 114 using the b-IMSI value. At 1008, the wireless device 102 obtains, from the asset server 502 associated with the MNO 114, a SUCI public key (PK) for encrypting an IMSI of the wireless device 102 associated with the MNO 114. At 1010, the wireless device 102 merges the SUCI PK into an eSIM template 306 associated with the MNO 114 to generate an eSIM 208 customized for the wireless device 102 and applicable for use with a cellular wireless network of the MNO 114.

### Representative Device

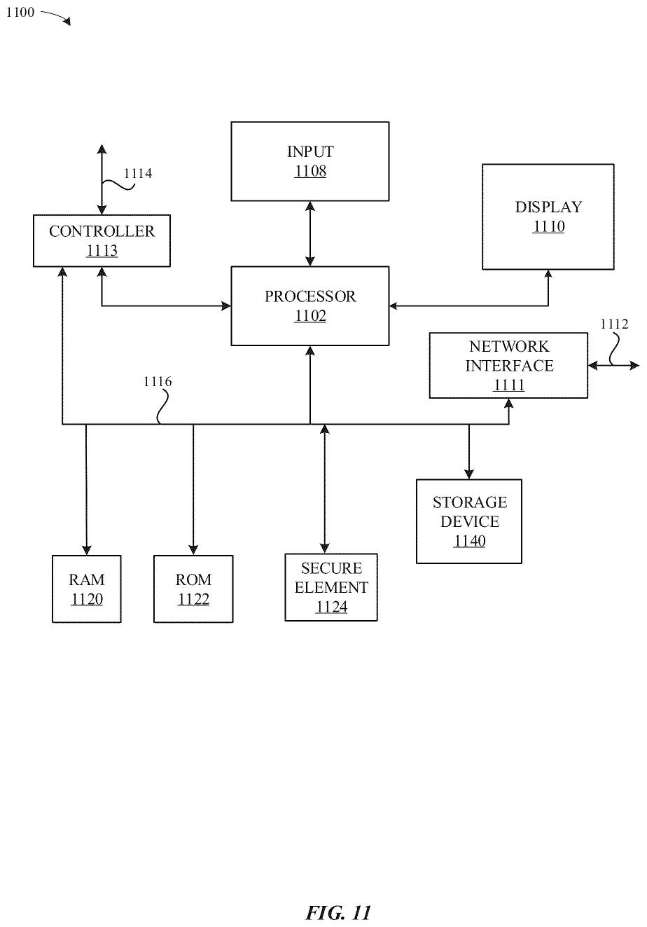

FIG. 11 illustrates a detailed view of a representative computing device 1100 that can be used to implement various methods described herein, according to some embodiments. In particular, the detailed view illustrates various components that can be included in the wireless device 102. As shown in FIG. 11, the computing device 1100 can include a processor 1102 that represents a microprocessor or controller for controlling the overall operation of computing device 1100. The computing device 1100 can also include a user input device 1108 that allows a user of the computing device 1100 to interact with the computing device 1100. For example, the user input device 1108 can take a variety of forms, such as a button, keypad, dial, touch screen, audio input interface, visual/image capture input interface, input in the form of sensor data, etc. Still further, the computing device 1100 can include a display 1110 that can be controlled by the processor 1102 to display information to the user. A data bus 1116 can facilitate data transfer between at least a storage device 1140, the processor 1102, and a controller 1113. The controller 1113 can be used to interface with and control different equipment through an equipment control bus 1114. The computing device 1100 can also include a network/bus interface 1111 that communicatively couples to a data link 1112. In the case of a wireless connection, the network/bus interface 1111 can include a wireless transceiver.

The computing device 1100 also includes a storage device 1140, which can comprise a single disk or a plurality of disks (e.g., hard drives), and includes a storage management module that manages one or more partitions within the storage device 1140. In some embodiments, storage device 1140 can include flash memory, semiconductor (solid state) memory or the like. The computing device 1100 can also include a Random Access Memory (RAM) 1120 and a Read-Only Memory (ROM) 1122. The ROM 1122 can store programs, utilities or processes to be executed in a non-volatile manner. The RAM 1120 can provide volatile data storage, and stores instructions related to the operation of the computing device 1100. The computing device 1100 can further include a secure element (SE) 1124, which can represent secure storage for cellular wireless system access by the wireless device 102, such as an eUICC 108 on which to store one or more eSIMs 208 and/or a UICC 118 on which to store a pSIM profile.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High-Speed Packet Access (HSPA+) network or a Code Division Multiple Access (CDMA) 2000 Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for dynamic customization of an electronic subscriber identity module (eSIM) associated with a mobile network operator (MNO), the method comprising:
by an embedded universal integrated circuit card (eUICC) of a wireless device:
obtaining, from a network server, data for the MNO;
providing, to a device processor of the wireless device, the data for the MNO; and
responsive to receipt of a binding command from the device processor, merging at least a portion of the data for the MNO with an eSIM template associated with the MNO to create an eSIM customized for the wireless device and applicable for use with a cellular wireless network of the MNO; and
by the device processor:
obtaining, from the eUICC, eSIM template information for one or more eSIM templates available in the eUICC;
determining the eSIM template associated with the MNO based on the eSIM template information;
when the eSIM template associated with the MNO is not available in the eUICC, assisting the eUICC to obtain and install the eSIM template associated with the MNO in the eUICC; and
sending, to the eUICC, the binding command to create the eSIM associated with the MNO and customized for the wireless device.

2. The method of claim 1, wherein the at least a portion of the data comprises an international mobile subscriber identity (IMSI) value associated with the MNO.

3. The method of claim 2, wherein:
the at least a portion of the data further comprises a group identifier level 1 (GID1) value and a group identifier level 2 (GID2) value; and
the MNO comprises a mobile virtual network operator (MVNO).

4. The method of claim 2, wherein the at least a portion of the data further comprises an authentication key (Ki) associated with the IMSI value.

5. The method of claim 1, wherein the eSIM template information comprises a list of eSIM templates indexed by at least one of: a mobile country code (MCC) value, a mobile network code (MNC) value, a group identifier level 1 (GID1) value, or a group identifier level 2 (GID2) value.

6. The method of claim 1, wherein assisting the eUICC to obtain and install the eSIM template associated with the MNO comprises:
by the device processor:
retrieving an eSIM template bound profile package (BPP) associated with the MNO from local storage of the wireless device; and
providing the eSIM template BPP to the eUICC.

7. The method of claim 1, wherein assisting the eUICC to obtain and install the eSIM template associated with the MNO comprises:
by the device processor:
sending, to an asset server associated with the MNO, a message requesting the eSIM template, the message including one or more identifiers for the MNO; and
receiving, from the asset server associated with the MNO, an eSIM template bound profile package (BPP) that includes the eSIM template associated with the MNO.

8. The method of claim 1, wherein assisting the eUICC to obtain and install the eSIM template associated with the MNO comprises:
by the device processor:
establishing a data connection to a provisioning server associated with the MNO; and
by the eUICC:
downloading, from the provisioning server, an eSIM template bound profile package (BPP) that includes the eSIM template associated with the MNO; and
installing, on the eUICC, the eSIM template extracted from the eSIM template BPP.

9. The method of claim 1, further comprising:
by the eUICC:
executing a secure channel protocol (SCP) script, pre-installed in the eUICC during manufacturing, to verify an eSIM template unprotected profile package (UPP) extracted from an eSIM template bound profile package (BPP) received from the device processor; and
installing the eSIM template from the eSIM template UPP after successful verification.

10. The method of claim 1, wherein
the data for the MNO comprises a bootstrap IMSI (b-IMSI) value associated with the MNO; and
the eUICC obtains the data for the MNO from the network server as part of a non-access stratum (NAS) attach procedure that uses an initial (i-IMSI) value pre-installed in the eUICC during manufacturing.

11. The method of claim 1, wherein the eSIM template for the MNO includes a proprietary applet specific to the MNO.

12. The method of claim 1, wherein the eSIM template for the MNO includes a proprietary authentication algorithm specific to the MNO.

13. The method of claim 1, wherein the eSIM template for the MNO includes a public key specific to the MNO to use to generate a subscription concealed identifier (SUCI) for the wireless device.

14. The method of claim 1, wherein determining the eSIM template associated with the MNO based on the eSIM template information comprises:
by the device processor:
selecting the eSIM template from a plurality of eSIM templates stored in the eUICC, wherein each eSIM template of the plurality of eSIM templates maps to a specific MNO.

15. The method of claim 1, wherein the eSIM associated with the MNO and customized for the wireless device comprises a limited functionality, bootstrap eSIM suitable for obtaining a full functionality user eSIM from a provisioning server of the MNO.

16. The method of claim 1, wherein the eSIM associated with the MNO and customized for the wireless device comprises a full functionality user eSIM for accessing cellular wireless service of the MNO.

17. A wireless device comprising:
wireless circuitry comprising one or more antennas and an embedded universal integrated circuit card (eUICC); and
one or more processors communicatively coupled to the wireless circuitry and to a memory storing instructions that, when executed by the one or more processors, configure the wireless device to:
by the eUICC:
obtain, from a network server, data for a mobile network operator (MNO);
provide, to a processor of the one or more processors, the data for the MNO; and
responsive to a binding command received from the processor, merge at least a portion of the data for the MNO with an eSIM template associated with the MNO to create an eSIM customized for the wireless device and applicable for use with a cellular wireless network of the MNO; and
by the processor:
obtain, from the eUICC, eSIM template information for one or more eSIM templates available in the eUICC;
determine the eSIM template associated with the MNO based on the eSIM template information;
when the eSIM template associated with the MNO is not available in the eUICC, assist the eUICC to obtain and install the eSIM template associated with the MNO in the eUICC; and
send, to the eUICC, the binding command to create the eSIM customized for the wireless device.

18. The wireless device of claim 17, wherein the processor is further configured to:
send, to an asset server associated with the MNO, a message requesting the eSIM template, the message including one or more identifiers for the MNO; and
receive, from the asset server associated with the MNO, an eSIM template bound profile package (BPP) that includes the eSIM template associated with the MNO.

19. The wireless device of claim 17, wherein the eUICC is further configured to:
execute a secure channel protocol (SCP) script, pre-installed in the eUICC during manufacturing, to verify an eSIM template unprotected profile package (UPP) extracted from an eSIM template bound profile package (BPP) received from the processor; and
install the eSIM template from the eSIM template UPP after successful verification.

20. A method for dynamic customization of an electronic subscriber identity module (eSIM) associated with a mobile network operator (MNO), the method comprising:
by a wireless device:
establishing a limited functionality bootstrap connection to an international mobile subscriber identity (IMSI) server using an initial IMSI (i-IMSI) value pre-installed in the wireless device during manufacturing;
obtaining, from the IMSI server, a bootstrap IMSI (b-IMSI) value applicable for the MNO;
establishing a second limited functionality bootstrap connection to an asset server associated with the MNO using the b-IMSI value;
obtaining, from the asset server associated with the MNO, a subscription concealed identifier (SUCI) public key (PK) for encrypting an IMSI of the wireless device associated with the MNO; and
merging the SUCI PK into an eSIM template associated with the MNO to generate an eSIM customized for the wireless device and applicable for use with a cellular wireless network of the MNO.
